(19) United States
(12) Patent Application Publication
(10) Pub. No.: US 2015/0262277 A1
(43) Pub. Date: Sep. 17, 2015

(54) SYSTEM AND METHOD FOR WEDDING PARTY MANAGEMENT BACKGROUND

(71) Applicant: Menguin, Inc., Bloomington, IN (US)

(72) Inventors: Michael Gassman, Bloomington, IN (US); Justin Delaney, Bloomington, IN (US); Kurt Sutton, Bloomington, IN (US)

(73) Assignee: Menguin, Inc., Bloomington, IN (US)

(21) Appl. No.: 14/656,863

(22) Filed: Mar. 13, 2015

Related U.S. Application Data
(60) Provisional application No. 61/952,327, filed on Mar. 13, 2014.

(51) Int. Cl. G06Q 30/06

(52) U.S. Cl. CPC G06Q 30/0621; G06Q 30/0635

(57) ABSTRACT

A computerized method and system for wedding party management is disclosed. The method includes receiving a clothing style selection from a user device, receiving a customization for the clothing style selection from the user device, associating the clothing style selection and the customization to at least one wedding party member, receiving measurements from the at least one wedding party member, receiving payment information from the at least one wedding party member, sending clothing to the wedding party member, the clothing being based on the clothing style selection and the customization.

### REFERENCE TO RELATED APPLICATION

The present application claims the benefit of U.S. Provisional Patent Application Ser. No. 61/952,327 filed Mar. 13, 2014, which is hereby incorporated by reference in its entirety.

### BACKGROUND

Planning a wedding is a stressful experience. From flowers to table settings, brides and grooms are required to make seemingly countless decisions in a short period of time, and track the progress of these decisions turning into realities up to and through their wedding day. Some couples hire outside wedding planners to guide them through the process, some rely on family support, and others do everything independently. Today, everything is planned manually and it is still commonplace for the soon-to-be bride to receive a wedding planner or other physical planning guide during her bridal shower.

One aspect of planning a wedding that is especially stressful for couples is picking out male formal wear and making sure all men who need such formal wear have it on time and have it sized appropriately. In most situations, out of town groomsmen, ushers, and family will be required the day before a wedding to visit a local tailor shop in person to pick up and make last-minute adjustments to such formal wear. The opportunity for stress is high at a time when the bride and groom are already preoccupied with other last-minute preparations. A failure by one wedding party member to have appropriate clothing can cause havoc to pictures and wedding line ups.

Finding an efficient way to select and customize formal wear, identify and invite men who need formal wear, obtain appropriate sizing for such men, and track and report on such men actually receiving such formal wear is a problem that has not yet been solved. Accordingly, there exists a need for a method and system for wedding party management.

### BRIEF DESCRIPTION OF THE DRAWINGS

FIG. 1A illustrates a flowchart of a system and method for wedding party management according to at least one embodiment of the present disclosure.

FIG. 1B illustrates a flowchart of a system and method for wedding party management according to at least one embodiment of the present disclosure.

FIG. 2 displays the architecture of a system for wedding party management according to at least one embodiment of the present disclosure.

FIG. 3 displays a screenshot of a user interface presented in association with a system and/or method for wedding party management according to at least one embodiment of the present disclosure.

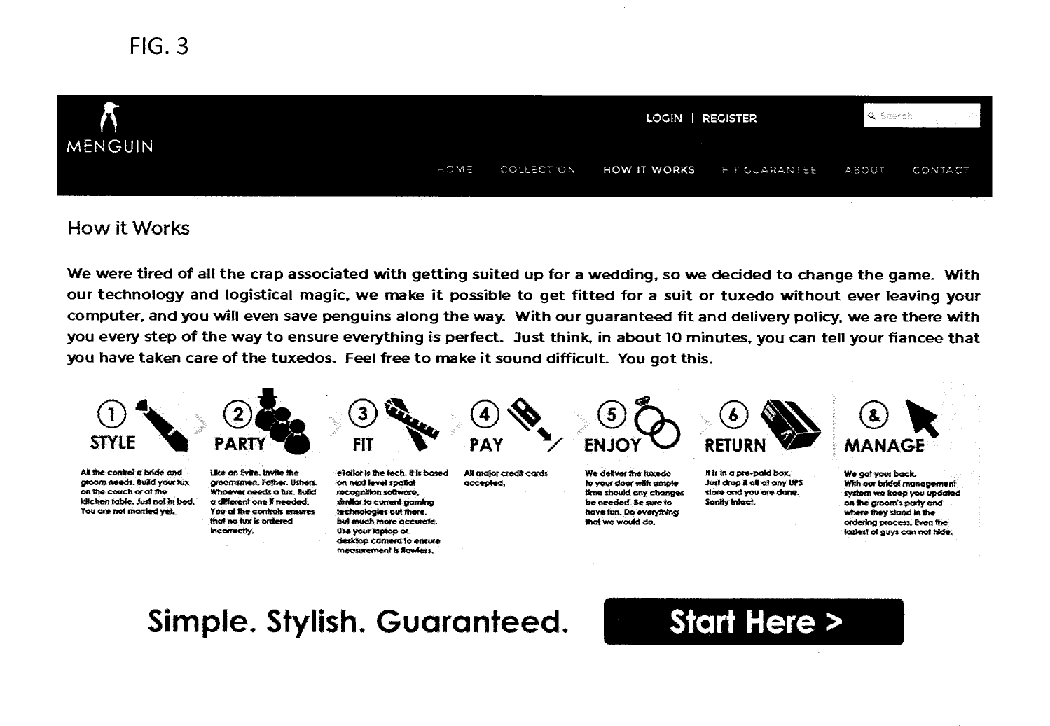

FIG. 4 displays a screenshot of a user interface presented in association with a system and/or method for wedding party management according to at least one embodiment of the present disclosure.

FIG. 5 displays a screenshot of a user interface presented in association with a system and/or method for wedding party management according to at least one embodiment of the present disclosure.

FIG. 6 displays a screenshot of a user interface presented in association with a system and/or method for wedding party management according to at least one embodiment of the present disclosure.

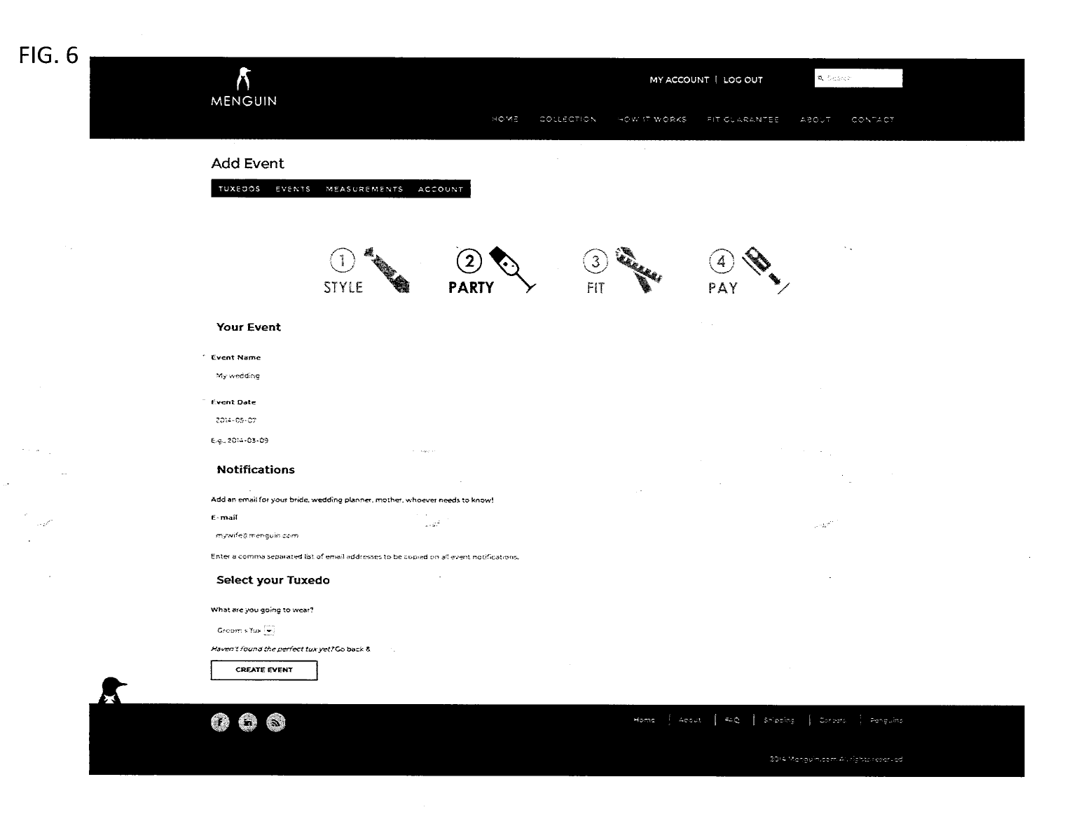

FIG. 7 displays a screenshot of a user interface presented in association with a system and/or method for wedding party management according to at least one embodiment of the present disclosure.

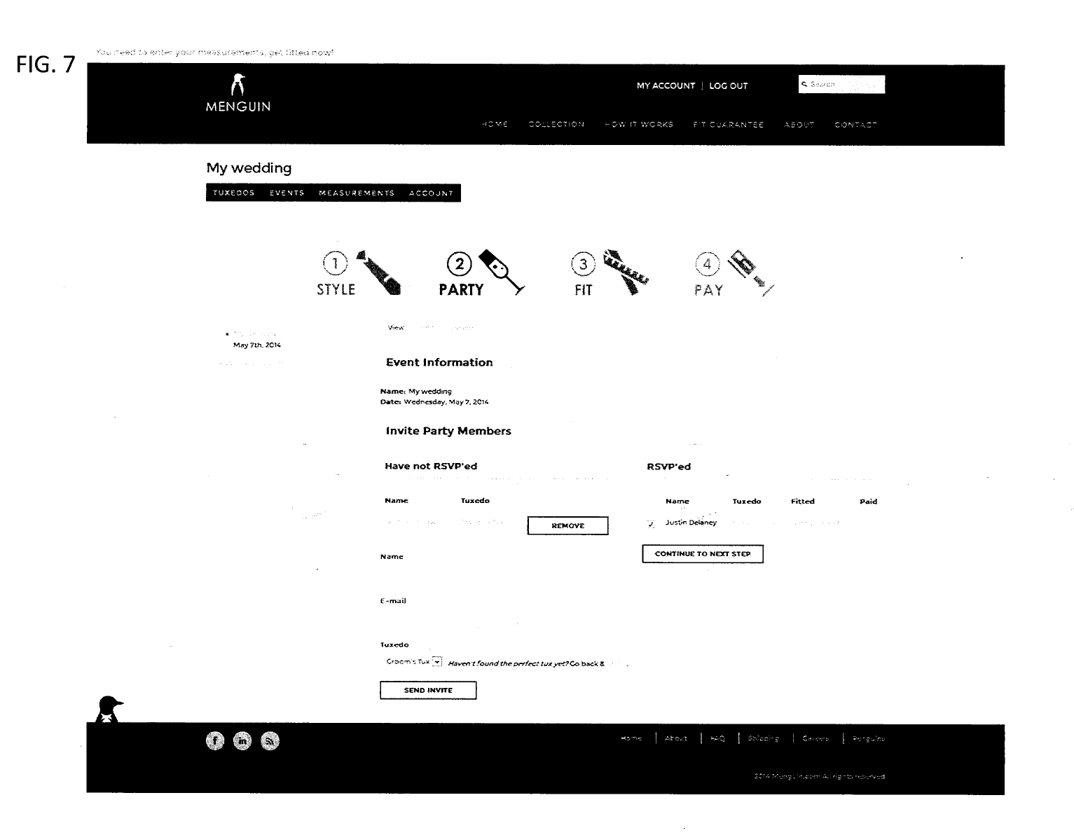

FIG. 8 displays a screenshot of a user interface presented in association with a system and/or method for wedding party management according to at least one embodiment of the present disclosure.

FIG. 9 displays a screenshot of a user interface presented in association with a system and/or method for wedding party management according to at least one embodiment of the present disclosure.

FIG. 10 displays a screenshot of a user interface presented in association with a system and/or method for wedding party management according to at least one embodiment of the present disclosure.

FIG. 11 displays a screenshot of a user interface presented in association with a system and/or method for wedding party management according to at least one embodiment of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

This detailed description is presented in terms of programs, data structures or procedures executed on a computer or network of computers. The software programs implemented by the system may be written in languages such as Ruby, PHP, Perl, ASP.net, Java, HTML, HTML5, Drupal, Python, C++, C#, Javascript, and/or the Go programming language. It should be appreciated, of course, that one of skill in the art will appreciate that other language may be used instead, or in combination with the foregoing and that web and/or mobile application frameworks may also be used, such as, for example, Ruby on Rails, Jo, Twitter bootstrap, and others. It should further be appreciated that the systems and methods disclosed herein may be embodied in software-as-a-service available over a computer network, such as, for example, through an application resident as a client on a user device in communication with the platform over the Internet.

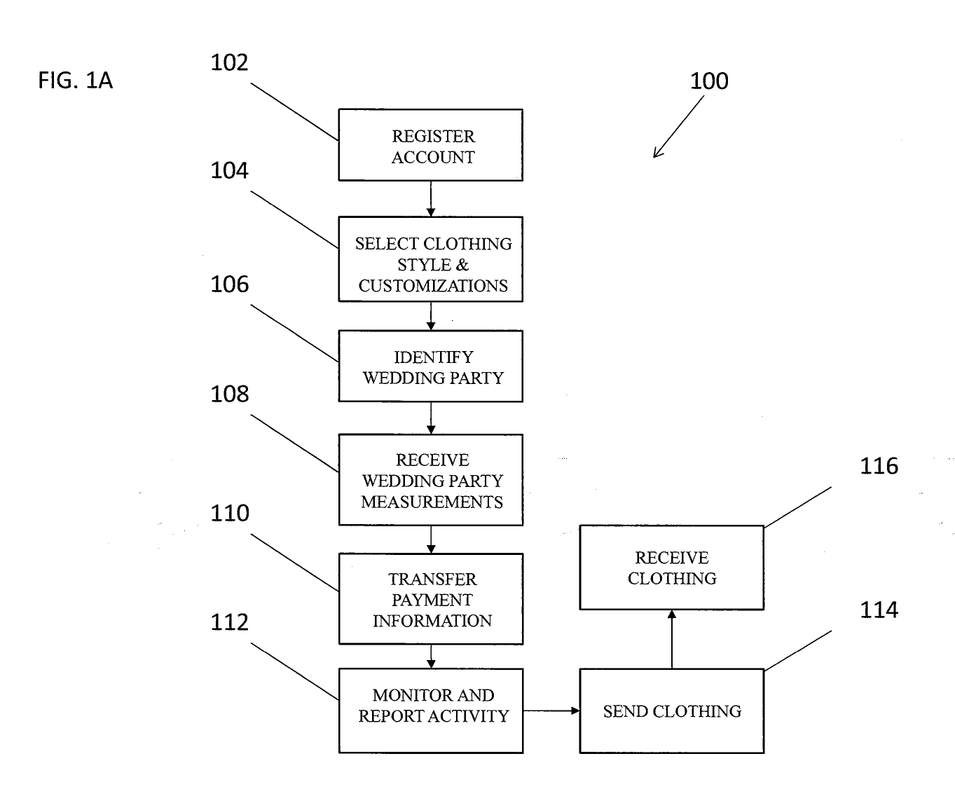

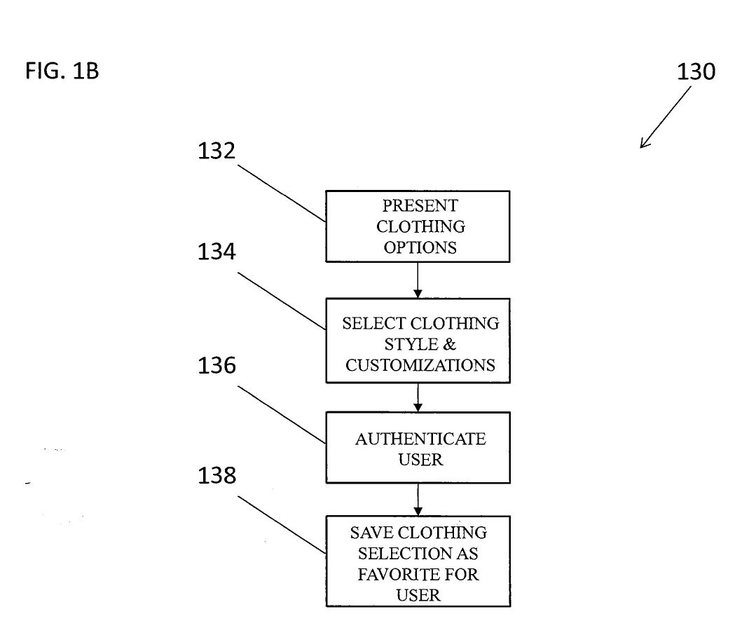

Referring now to FIG. 1A, it is shown a method 100 for managing a wedding party. As shown in FIG. 1A, the method 100 includes registering an account in step 102, selecting clothing style and customizations in step 104, identifying a wedding party in step 106, receiving measurements for each member of a wedding party in step 108, transferring payment information in step 110, monitoring and reporting activity in step 112, sending clothing to the wedding party in step 114, and receiving clothing from the wedding party in step 116.

In at least one embodiment of the present disclosure, the method 100 includes registering an account in step 102. In such an embodiment, a user may access a webserver available over a computer network, such as, for example, the Internet, from a user device. As used in the present disclosure, a user device may include, but is not limited to, a laptop, personal computer, smartphone, or other network-capable device. In such an embodiment, the webserver may transmit to the user device over the computer network a website for rendering on the user device, whether in a browser, mobile application, or otherwise.

In such an embodiment, the website may be configured to establish a session for the user (i.e. through cookie or otherwise). To identify the user, the website may request that the user register an account in step 102. To register an account, the website may prompt the user to provide personal information, like name, email address, age, and others. The website may also ask the user to provide information specific to managing a wedding party, like the date of the user's wedding, the name of the user's spouse, or other information.

In such an embodiment, the user may create an account with the website in step 102 by providing an account name and password. In other embodiments, the website may be configured to integrate with third-party authentication services, such as, for example, OAuth and/or openid. Upon registering for an account in step 102, the webserver or other infrastructure may send a confirmation email to the user at the user-provided email address asking the user to verify his or her account. Upon arriving to the website at a later time, the user may login with his or her account and establish a session with the website for the duration of the visit.

In at least one embodiment of the present disclosure, the method 100 includes selecting clothing and customizations for such clothing in step 104. In such an embodiment, the user intends to identify and customize a set of formal wear for men in his or her wedding party. These men may be participating as ushers, groomsmen, fathers, grandfathers, a husband, a spouse, or any other person in a wedding party that might need to have customized formal wear for a wedding.

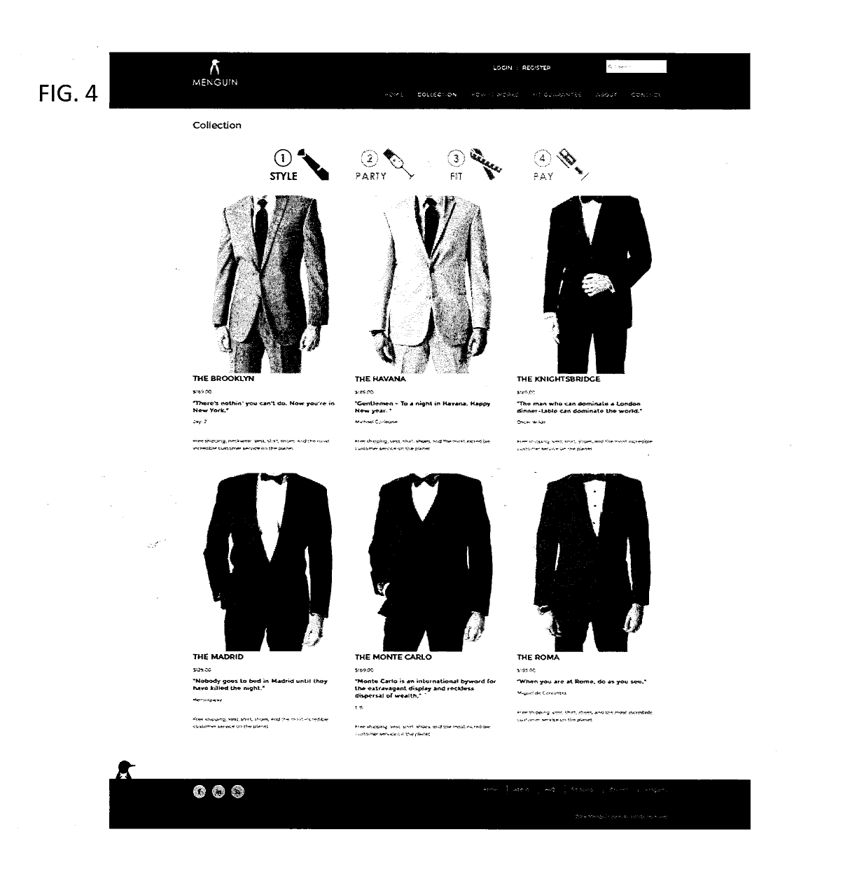

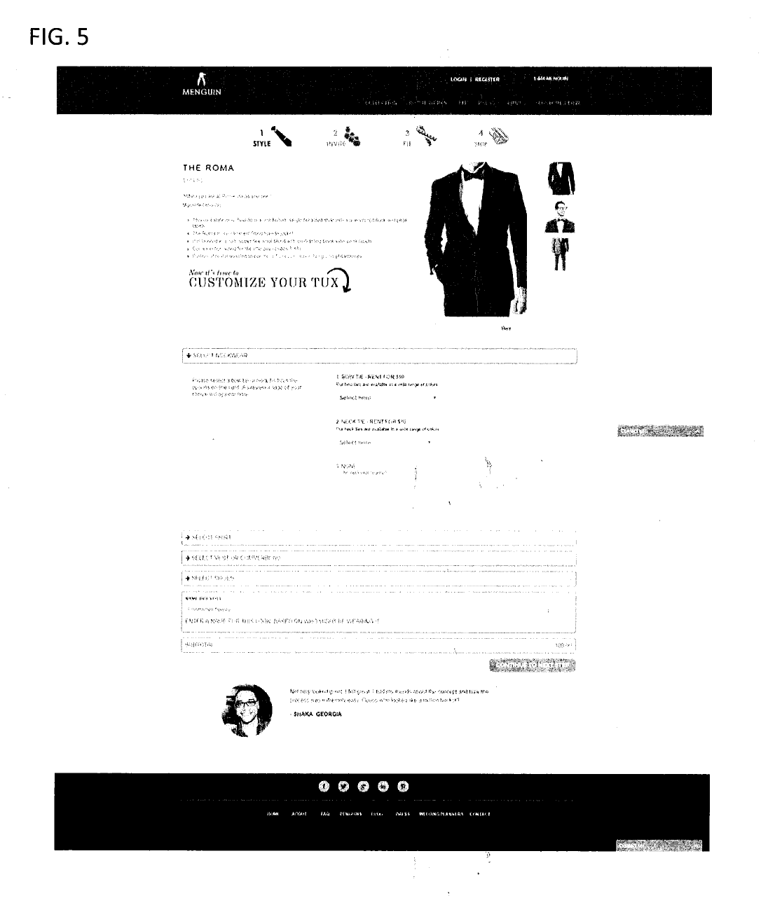

In such an embodiment, the webserver may present the user a website that enables him or her to browse formal clothing options and customizations. In step 104, the user may select different types of general suits and tuxedos, such as, for example, those shown on FIG. 4. These suits and tuxedos may be offered from a variety of providers with costs and descriptions for each option. After selecting a suit or tuxedo, the user may then customize his or her selection with selected neckware, shirts, overwear, shoes, special coloring, and other options, such as, for example, those shown in FIG. 5. In at least one embodiment, the user will be able to view each different clothing option holistically with the other choices, and mix and match, seeing their changes reflected in real-time on a single representative figure.” It should be appreciated that the ‘All-in-one’ view of the tuxedo (aka Menguin Mannequin) fulfills the ability to see style changes in real time, with the addition of a bridal gown for matching comparison.

It should be appreciated that the step 104 may be repeated for various members of the wedding party with different selections. For example, a user may desire to select a Roma tuxedo for himself as a groom to save in a favorites list. Upon customizing his selection, he might select a white bow tie, a standard tuxedo shirt, normal patent leather shoes, and a black vest. After selecting this clothing and customizations, the website may prompt the user to save it in his or her favorite clothing styles. In this example, he may identify the selections in his favorites as “The Groom's Tux.” The user may repeat step 104 to select clothing for other members of the wedding party to save in his favorite for later use. For example, the user may choose a suit, such as, for example, the Brooklyn suit shown on FIG. 4 to be associated with an usher. In this example, the user may then customize this selection for the usher with a black tie, standard dress shirt, cummerbund, and leather shoes. The user may repeat this process for each member of the wedding party. After selecting this clothing and customizations, the user may save the style as a favorite in the website identified with a name, such as, for example, “Usher Selections.”

It should be appreciated, then, that the step 104 may be repeated as the user selects clothing and customizes said clothing for saving in his favorite styles. More detail is provided for the clothing selection and customization options in, for example, method 130 of FIG. 1B.

In at least one embodiment of the present disclosure, the method 100 includes identifying the wedding party in step 106. In such an embodiment, the user may identify individual members of his or her wedding party. In such an embodiment, the user may input each wedding party member's name, role in the wedding, email address, and clothing style from the selected favorites in step 104. In such an embodiment, each member of the wedding party may be associated with a different clothing style from the selected favorites in step 104.

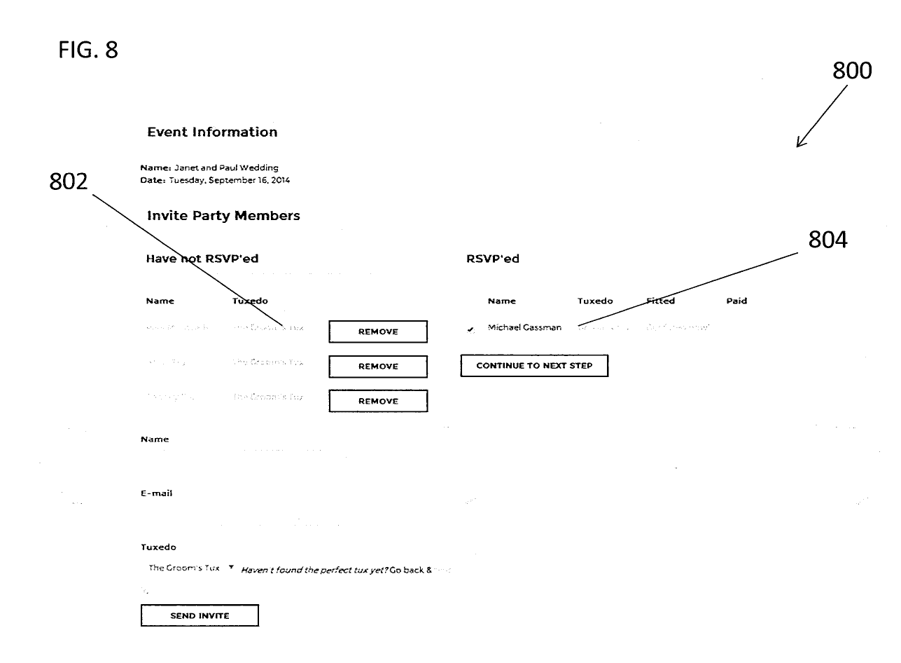

For example, in FIG. 8, the user has identified four members of the wedding party: Paul Monteath, Brian Rey, Johnny Bui, and Michael Gassman. In this example, each member of the wedding party has been associated with “The Groom's Tux” which is a pre-selected favorite from the user of a clothing style and assorted customizations. In another example, the user could select a different set of clothing for a specific member of the wedding party. In this example, the user could choose “Usher Selections” from the pre-selected favorites for Michael Gassman.

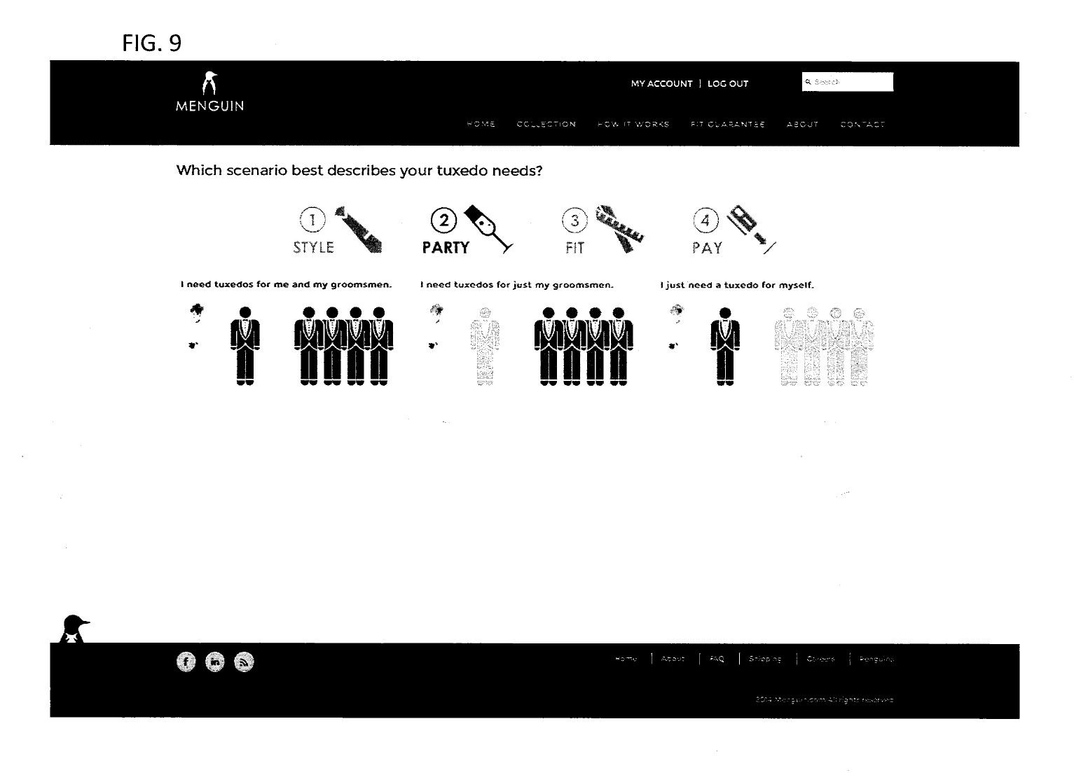

In step 106, the user may also work through a wizard-based approach through the website to help identify how to populate the wedding party and assorted clothing selections, such as, for example, the graphical user interface shown in FIG. 9. In such an embodiment, the user may choose to select clothing options for himself and all groomsmen, just his groomsmen, just himself, and also add in other wedding party members who may need formal wear, like ushers, grandparents, parents, etc.

After the user has identified all wedding party members and associated clothing styles and customizations, the webserver or other infrastructure may send invitations to each member of the wedding party. The invitations may be in the form of emails, social media messages, text messages. In at least one embodiment, such messages may include links to the website, or other communication that would direct the wedding party member to a website.

In at least one embodiment of the present disclosure, the method 100 includes receiving wedding party measurements in step 108. In such an embodiment, one or more members of the wedding party will interact with the invitations sent in step 106 with a user device. In such an embodiment, the wedding party member's user device will visit a website which will ask the wedding party member to purchase the selected clothing style and customization for the wedding as identified by the user. In such an embodiment, the wedding party member will then transfer his or her measurements through the website. If the wedding party member does not know his or her measurements, the website may prompt the wedding party member to take his or her measurements with an available webcam or camera.

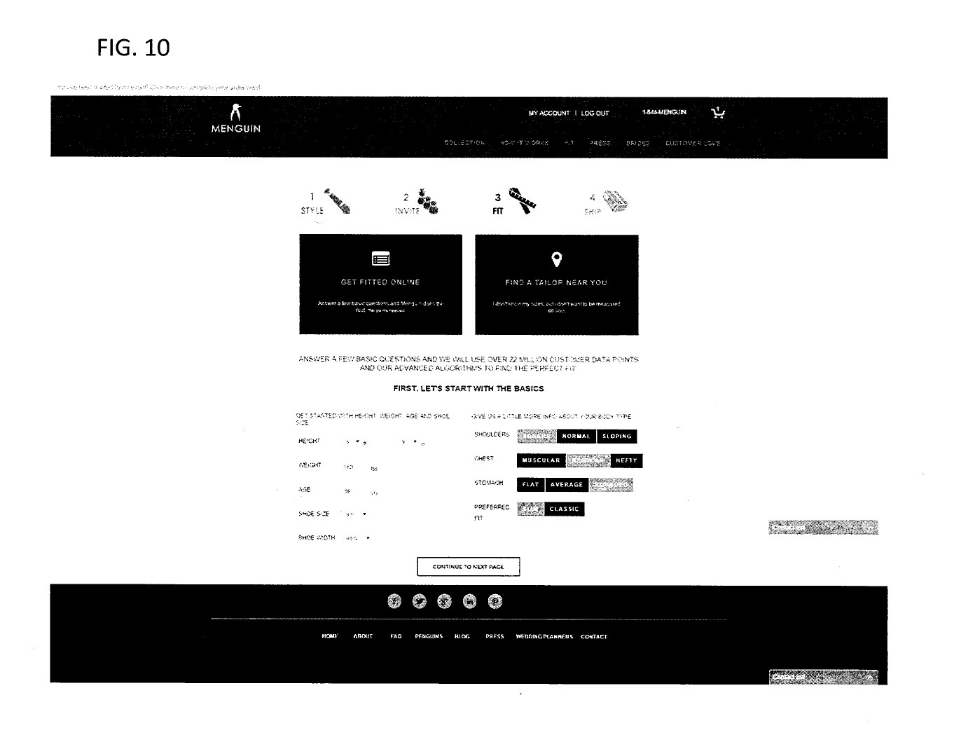

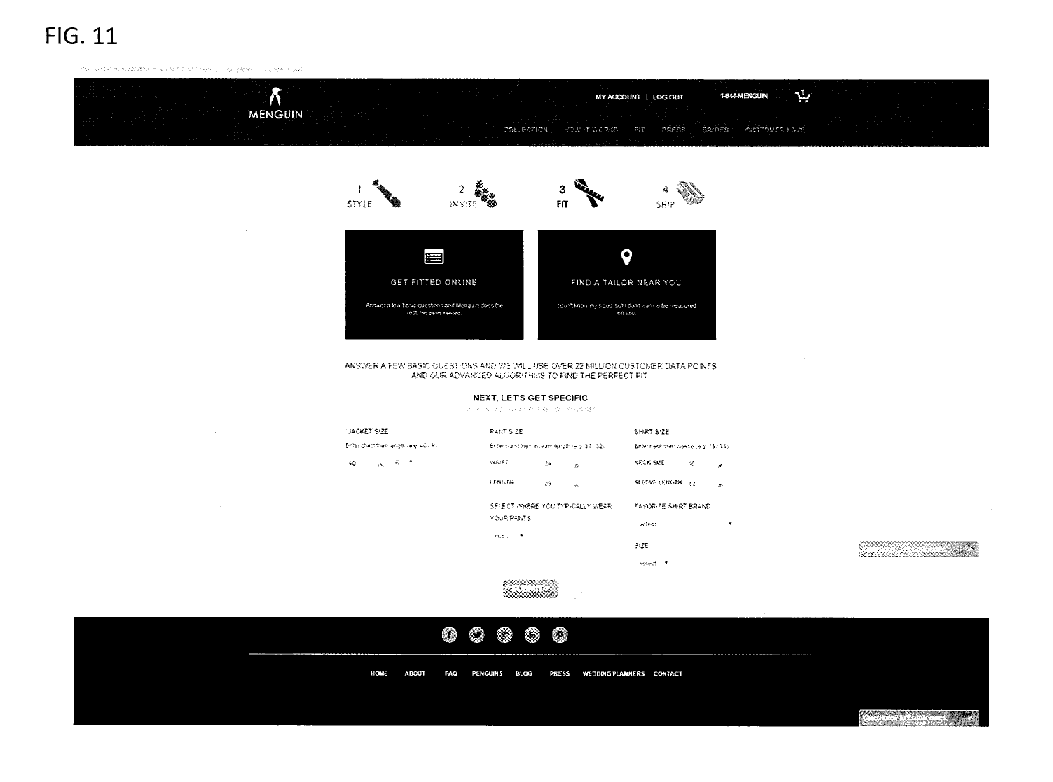

In such an embodiment, a full-bodied image of the wedding party member with a reference item of a known size (i.e. soda can, compact disc, ruler) may enable an accurate analysis of the wedding party member's body and, therefore, accurate measurements for clothing. For example, a groomsman receives an invitation over email that the groom of the wedding he is participating in has selected clothing and customizations via a website for the groomsman to purchase. The groomsman clicks on a link within the invitation through his user device and is presented with a website showing the groomsman the selected clothing and customizations. The groomsman chooses to purchase the clothing with the selected customizations and then is asked to provide his measurements on the website. If the groomsman knows his measurements, he may input them via a standard text form through the website, such as, for example, the form displayed in FIG. 10 and/or FIG. 11. However, if the groomsman does not know his measurements, the platform may prompt the groomsman to take a full-length photo of himself with a reference item, like a compact disc, in front of him. The platform may activate the groomsman's webcam to give him a preview of the picture that will be taken, therefore enabling him to move in the webcam's view with the reference item to guarantee a quality picture.

After the groomsman takes the photo with the webcam, the photo is transmitted through the user device to the webserver and analyzed. By using the known size of the reference item, the picture may be analyzed to find measurements of the groomsman. For example, if the groomsman used a compact disc as a reference item, a standard compact disc is 120 millimeters in diameter and, therefore, the diameter of a compact disc on the picture may be used as a 120 millimeter reference point for the remainder of the picture, which enables the identification of the groomsman's measurements.

It should be appreciated that the website may prompt the wedding party member to take multiple pictures from multiple viewing angles in order to achieve more accurate measurements. For example, the groomsman may take a photo with the webcam from the front, back, and side.

In some embodiments, wedding party members may not have a webcam and may not know measurements to provide through the website. In such embodiments, the wedding party member may acknowledge this through the website and be presented with a list of available tailors and clothing retailers where he may go to get measured. The list of tailors and clothing retailers may be generated based on a zip code, geographic location, or other location-based information known to the website for the wedding party member, such as information provided by the wedding party member, groom, or otherwise. In such embodiments, the wedding party member will be directed to visit the tailor or clothing retailer of his or her choice in order to get measured and then send such measurements through the website at a later time.

In some embodiments, the wedding party members may input information to generate a derived measurement. The wedding party members may input height, weight, age, shoe size, shoe width, and body type. Each type of information may request sub-information in order to generate the derived measurement. For example, body type may request a shoulder build, chest build, stomach type, and preferred fit.

After identifying the groomsman's measurements, the groomsman then is prompted to pay for the selected clothing and customizations at his measurements. In step 110, the groomsman transfer payment information through the website to effectuate the purchase. The groomsman may transfer payment information via any ecommerce solution available, such as, for example, Paypal, direct credit card transaction, or other payment method. It should further be appreciated that the website may be configured to enable a wedding party member to forward a payment request to a third party (i.e. groom, father, brother, etc.) to help the wedding party member pay for the clothing.

While the invitations to various wedding party members are out, the webserver monitors and reports on activity of the invitations to the original user (i.e. bride, groom, wedding planner, etc.) through his or her user account in step 112. This tracking information may provide the user with a point-in-time view of which wedding party members have logged onto the website, purchased the selected clothing and customizations, and even what, if any, wedding party members have received clothing. It should be appreciated that the monitoring and reporting interface may be updated in real time as wedding party members interact with the website.

In at least one embodiment of the present disclosure, the method 100 includes sending clothing to each wedding party member in step 114 and receiving clothing from each wedding party member in step 116. In such an embodiment, for each wedding party member who has purchased clothing and assorted customizations in step 110, the webserver will direct the appropriate clothing retailer to ship clothing to such wedding party members in step 114. In such an embodiment, the clothing shipped to each wedding party will conform to the styles and customizations purchased by the wedding party member and the measurements transmitted through the website in step 108. Accordingly, in one embodiment, the clothing that arrives for the wedding party member will be a complete package of all clothing needed for that wedding party member for the wedding. In such an embodiment, the clothing will be shipped to the wedding party member at his or her choice of receipt, like a personal address or work address. It should be appreciated that the wedding party members will not be required to visit a brick-and-mortar store to pick up clothing, adjust clothing, or the like. By purchasing the clothing with appropriate measurements through the website, the clothing arriving to the wedding party member will be ready to wear.

The clothing shipped to the wedding party members in step 114 will conform to the clothing purchased by such wedding party member in step 110. In such an embodiment, the clothing may include, but is not limited to, tuxedos, suits, shirts, shoes, outerwear, ties, bowties, and other assorted clothing selected by the wedding party.

After the wedding, the wedding party member will return the clothing in step 116. In some embodiments, the package containing the clothing to the wedding party member shipped in step 114 will include a prepaid shipping label thereby enabling the wedding party member to put all of the clothes back in the package it was shipped in (or in another package) and send such clothing back to the clothing retailer in step 116.

Referring now to FIG. 1B, it is shown a method 130 for managing a wedding party according to at least one embodiment of the present disclosure. As shown in FIG. 1B, the method 130 includes presenting clothing options in step 132, selecting clothing style and customizations in step 134, authenticating a user in step 136, and saving clothing selections as favorites for the user in step 138.

In at least one embodiment, the method 130 includes presenting clothing options for male members of a wedding party in step 132. In such an embodiment, a webserver may transmit a webpage to a user device for rendering in a browser which displays clothing options for a wedding. In other embodiments, the options may be viewed by the user device in a mobile application which accesses the website or in a mobile browser. The clothing options presented to the user in step 132 may include tuxedos, suits, and other format wear, such as those identified in FIG. 4.

After browsing through the various clothing options, a user may identify one option for customization in step 134. In such an embodiment, after selecting an individual suit, tuxedo, or other formal wear for customization, the website directs the user to a customization page that presents the user with options to include additional pieces with the selection, like a bow tie, tie, overwear, cummerbund, vest, specific shoes, or others, such as those shown, for example, in FIG. 5.

It should be appreciated that the user may choose to not select a piece in customization. For example, if the user is not interested in including a cummerbund or vest with the selection, he or she may select that no outerwear be included in the customization. In another example, the user may select to not include a bowtie or tie with the formal wear selected.

After the user selects a clothing style and assorted customizations, the website may ask the user to authenticate in step 136. In such an embodiment, if the user has a pre-existing account on the website (such as one created in step 102 of the method 100), the user may authenticate to the website using his or her credentials. If the user does not have an existing account on the website, the website will ask the user to register for one. Upon authenticating, the website may then save the selected clothing style and customizations in the user's account favorite list for later association with a wedding party member in step 138. In such an embodiment, the user may select a name for the favorite to help identify it later when associating with a wedding party member.

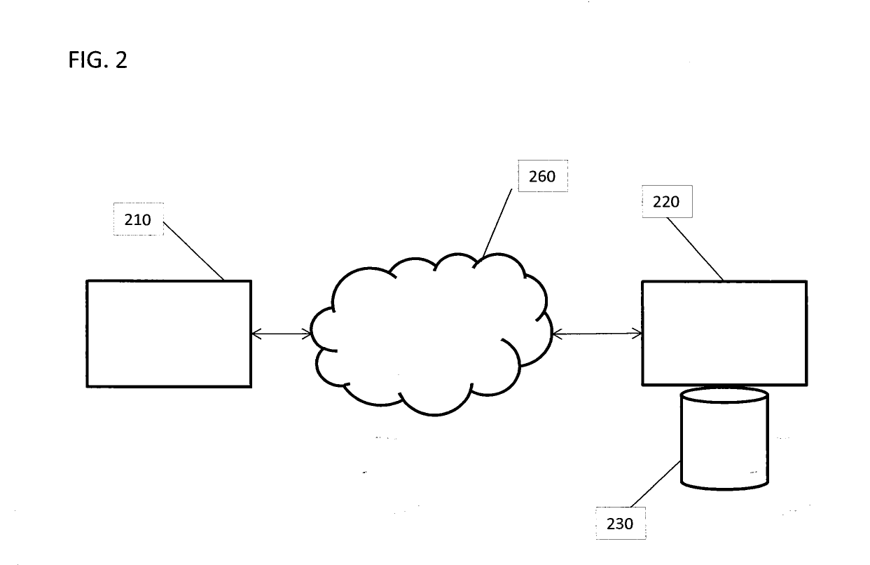

Referring now to FIG. 2, there is shown at least one embodiment of the components of the system 200 for managing a wedding party according to at least one embodiment of the present disclosure. System 200 comprises user device 210, server 220, database 230, and computer network 260. For purposes of clarity, only one user device 210 is shown in FIG. 2. However, it is within the scope of the present disclosure that the system 200 may include any number of user devices 210 at one time.

The user device 210 may be configured to transmit information to and generally interact with a web services infrastructure housed on server 220 over computer network 260. The user device 210 may include a web browser, mobile application, or other network connected software such that communication with the web services infrastructure on server 220 is possible over the computer network 260. User device 210 includes one or more computers, smartphones, tablets, wearable technology, computing devices, or systems of a type well known in the art, such as a mainframe computer, workstation, personal computer, laptop computer, hand-held computer, cellular telephone, or personal digital assistant, video game system. User device 210 comprises such software, hardware, and componentry as would occur to one of skill in the art, such as, for example, one or more microprocessors, memory systems, input/output devices, device controllers, and the like. User device 210 also comprises one or more data entry means (not shown in FIG. 2) operable by users of user device 210 for data entry, such as, for example, a pointing device (such as a mouse), keyboard, touchscreen, microphone, webcam, camera, voice recognition, and/or other data entry means known in the art. User device 210 also comprises a display means (not shown in FIG. 2) which may comprise various types of known displays such as liquid crystal diode displays, light emitting diode display, and the like upon which information may be display in a manner perceptible to the user.

As described above, the server 220 may be configured to receive authentication information, clothing selections, customizations, wedding party information, and other information from the user device 210 to establish a wedding party and associated formal wear. In at least one embodiment, the server 220 accesses the database 230 to store wedding party information, favorite clothing styles and customizations, and other information transmitted from the user device 210 or generated through its interaction with the server 220 in the methods and disclosed herein. The server 220 is configured to carry out one or more of the steps of methods described herein. For example, the server 220 may perform steps 102, 104, and 106, 108, 110, and 112 of the method 100. It should be appreciated that the server 220 may also perform any or all of the steps of the methods disclosed herein.

The user device 210 is further configured to provide input to the server 220 to carry out one or more of the steps of the methods described herein. Server 220 comprises one or more server computers, computing devices, or systems of a type known in the art. Server 220 further comprises such software, hardware, and componentry as would occur to one of skill in the art, such as, for example, microprocessors, memory systems, input/output devices, device controllers, display systems, and the like. Server 220 may comprise one of many well-known servers and/or platforms, such as, for example, IBM's AS/400 Server, RedHat Linux, IBM's AIX UNIX Server, MICROSOFT's WINDOWS NT Server, AWS Cloud services, Rackspace cloud services, any infrastructure as a service provider, or any platform as a service provider.

In FIG. 2, server 220 is shown and referred to herein as a single server. However, server 220 may comprise a plurality of servers, virtual infrastructure, or other computing devices or systems interconnected by hardware and software systems know in the art which collectively are operable to perform the functions allocated to server 220 in accordance with the present disclosure.

The database 230 is configured to store wedding party information (i.e. name, email address, selections, formal wear purchases, measurements), clothing styles and customizations, and other information. Database 230 is “associated with” server 220. According to the present disclosure, database 230 can be “associated with” server 220 where, as shown in the embodiment in FIG. 2, database 230 resides on server 220. Database 230 can also be “associated with” server 220 where database 230 resides on a server or computing device remote from server 220, provided that the remote server or computing device is capable of bi-directional data transfer with server 220, such as, for example, in Amazon AWS, Rackspace, or other virtual infrastructure, or any business network. In at least one embodiment, the remote server or computing device upon which database 230 resides is electronically connected to server 220 such that the remote server or computing device is capable of continuous bi-directional data transfer with server 220.

For purposes of clarity, database 230 is shown in FIG. 2, and referred to herein as a single database. It will be appreciated by those of ordinary skill in the art that database 230 may comprise a plurality of databases connected by software systems of a type well known in the art, which collectively are operable to perform the functions delegated to database 230 according to the present disclosure. Database 230 may comprise a relational database architecture or other database architecture of a type known in the database art. Database 230 may comprise one of many well-known database management systems, such as, for example, MICROSOFT's SQL Server, MICROSOFT's ACCESS, or IBM's DB2 database management systems, or the database management systems available from ORACLE or SYBASE. Database 230 retrievably stores information that are communicated to database 230 from user device 210 or server 220.

User device 210 and server 220 communicate via computer network 260. If database 230 is in disparate infrastructure from server 220, database 230 may communicate with server 230 via computer network 260. Computer network 260 may comprise the Internet, but this is not required.

Referring now to FIG. 8, it is shown a graphical user interface 800 for managing a wedding party generated through execution of one or more of the methods disclosed herein and/or through the system disclosed herein. In the graphical user interface 800, a user may manage his or her wedding party and activity associated with selecting and distributing formal wear in one location. For example, the graphical user interface 800 provides a listing of all members of the wedding party 802 who have not responded to invitations sent for the purchase of formal wear. In this example, Paul Monteath, Brian Rey, and Johnny Bui have each been assigned “The Groom's Tux” clothing style and assorted customizations favorite for purchase for the wedding on Tuesday, Sep. 16, 2014 for the “Janet and Paul Wedding.” However, in this example, it is shown that most of these invitees have not purchased the formal wear as requested in invitations sent out through the system. In this example, the only invitee who has responded to the invitation is Michael Grassman 804, and he may send his measurements through the platform.

It should be appreciated that the graphical user interface 800 enables a bride and groom to see a point-in-time representation of all members of their wedding party, including what clothing each member will be wearing, whether each wedding party member has responded to invitations, provided measurements, and paid for formal wear, and also allow the bride and groom to add new wedding party members in one location. In addition, the graphical user interface 800 is configured to enable a user to send notifications at specified date intervals to remind “deadbeat” groomsmen to purchase formal wear.

While the description above refers to particular embodiments of the present invention, it will be understood that many modifications may be made without departing from the spirit thereof. The accompanying concepts are intended to cover such modifications as would fall within the true scope and spirit of the present invention. The presently disclosed embodiments are therefore to be considered in all respects illustrative and not restrictive, the scope of the invention being indicated by the appended concepts, rather than the foregoing description, and all changes which come within the meaning and range of equivalency of the concepts are therefore intended to be embraced therein.

What is claimed is:

1. A computerized method for wedding party management, the method comprising:
receiving a clothing style selection from a user device;
receiving a customization for the clothing style selection from the user device;
associating the clothing style selection and the customization to at least one wedding party member;
receiving measurements from the at least one wedding party member;
receiving payment information from the at least one wedding party member; and
sending clothing to the wedding party member, the clothing being based on the clothing style selection and the customization.

2. The method of claim 1, wherein the user device is a personal computer.

3. The method of claim 1, wherein the user device is a mobile phone.

4. The method of claim 1, wherein the measurements comprise height, weight, age, shoe size, shoe width, and body type.

5. The method of claim 4, wherein body type comprises a shoulder build, chest build, stomach type, and preferred fit.

6. The method of claim 1, further comprising:
receiving a geographic location of the at least one wedding party member, the geographic location being obtained from a second user device; and
transmitting, to the second user device, locations of nearby tailors based on the geographic location.

7. The method of claim 6, wherein the measurements are transmitted from one of the nearby tailors.

8. The method of claim 1, wherein the measurements are derived from one or more attributes associated with the wedding party member.

9. The method of claim 8, wherein the one or more attributes comprises at least one of a shoulder build, chest build, stomach type, and preferred fit.

10. A computerized method for wedding party management, the method comprising:
receiving at least one clothing style selection from a user device;
receiving at least one customization for the at least one clothing style selection from the user device;
receiving a plurality of wedding party member information from the user device, each wedding party member information in the plurality of wedding party member information being associated with a wedding party member and comprising a name, email address, and at least one customization for the at least one clothing style selection;
receiving measurements from each wedding party member;
receiving payment information from each wedding party member; and
sending clothing to each wedding party member, the clothing being based on the clothing style selection and the customization associated with each wedding party member.

11. The method of claim 10, wherein the measurements comprise height, weight, age, shoe size, shoe width, and body type.

12. The method of claim 11, wherein body type comprises a shoulder build, chest build, stomach type, and preferred fit.

13. The method of claim 10, further comprising:
receiving a geographic location of the at least one wedding party member, the geographic location being obtained from a second user device; and
transmitting, to the second user device, locations of nearby tailors based on the geographic location.

14. The method of claim 13, wherein the measurements are transmitted from one of the nearby tailors.

15. The method of claim 10, wherein the measurements are derived from one or more attributes associated with the wedding party member.

16. The method of claim 15, wherein the one or more attributes comprises at least one of a shoulder build, chest build, stomach type, and preferred fit.

17. A system, the system comprising:
a user device; and
a server, the server being configured to transmit a graphical user interface for rendering on the user device, the graphical user interface being configured to enable a user of the user device to:
identify at least one member of a wedding party;
provide contact information for the at least one member;
identify a favorite, the favorite comprising a clothing style and customization of the clothing style;
associate the favorite with the at least one member;
send an invitation to the at least one member, the invitation comprising a referral to a payment system configured to enable the member to purchase the favorite; and
send an order to a clothing supplier for shipment of the purchased favorite to the member.

18. The system of claim 10, wherein the measurements comprise height, weight, age, shoe size, shoe width, and body type.

19. The system of claim 18, wherein body type comprises a shoulder build, chest build, stomach type, and preferred fit.

20. The system of claim 17, further comprising a second user device and wherein the server is further configured to:
receive a geographic location of the at least one wedding party member, the geographic location being obtained from a second user device; and
transmit, to the second user device, locations of nearby tailors based on the geographic location.
